(19) United States
(12) Patent Application Publication
(10) Pub. No.: US 2018/0007313 A1
(43) Pub. Date: Jan. 4, 2018

(54) NETWORK INTERFACE DEVICE

(71) Applicant: PPC Broadband, Inc., East Syracuse, NY (US)

(72) Inventors: Paul Bailey, Camillus, NY (US); Yan Li, Syracuse, NY (US)

(21) Appl. No.: 15/638,514

(22) Filed: Jun. 30, 2017

Related U.S. Application Data
(60) Provisional application No. 62/356,830, filed on Jun. 30, 2016.

(51) Int. Cl. H04N 7/10; H04N 7/173; H04B 3/38

(52) U.S. Cl. CPC H04N 7/104; H04B 3/38; H04N 7/173

(57) ABSTRACT

The present disclosure provides network interface device including a circuit that, in a powered state, receives a downstream radio-frequency (RF) signal from a source via an entry port, provides a portion of the downstream RF signal to a first input/output port via a passive signal path, and provides a second portion of the downstream RF signal to a second input/output port via an active signal path. Additionally, in an unpowered state, the circuit receives the downstream RF signal from the source via the entry port, provides the downstream RF signal to first input/output port via a second passive signal path, and isolates the active signal path and a first passive signal path from the second passive signal path.

### FIELD

The present disclosure is directed to cable television (CATV) network communication devices. More particularly, the present disclosure relates to an entry adapter for a CATV network.

### BACKGROUND

CATV networks supply and distribute high frequency “downstream” signals from a main signal distribution facility, known as a “headend,” to premises (e.g., homes and offices) of subscribers. The downstream signals can be provided to subscriber equipment, such as televisions, telephones, and computers. In addition, most CATV networks also receive “upstream” signals from subscriber equipment back to the headend of the CATV network. For example, a set top box can send an upstream signal including information for selecting programs for viewing on a television. Also, upstream and downstream signals are used by personal computers connected through the CATV infrastructure to the Internet. Further, voice over Internet protocol (VOIP) telephones use upstream and downstream signals to communicate telephone conversations.

To permit simultaneous communication of upstream and downstream signals, and to permit interoperability of the subscriber equipment and the equipment associated with the CATV network infrastructure, the downstream and upstream signals are confined to two different frequency bands. For example, in CATV networks, the downstream frequency band can be within the range of about 54 to 1002 megahertz (MHz) and the upstream frequency band can be within the range of about 5 to 42 MHz.

Downstream signals can be delivered from infrastructure of the CATV network to the subscriber premises via a network interface device (a.k.a., an entry device, an entry adapter, a terminal adapter, or a drop amplifier). A network interface device can be a multi-port device, in which an upstream entry port connects to a drop cable from the infrastructure of the CATV network, and one or more input/output ports (hereinafter “ports”) connect to subscriber equipment distributed around a premises of a subscriber.

The network interface device can include two paths: an active signal communication path and a passive signal communication path. The active signal communication path can include active components (e.g., powered devices) that amplify and/or condition downstream signals received from the CATV infrastructure and conduct them to one or more ports of the CATV entry adapter. Subscriber equipment connected to these active ports benefit from this amplification of the CATV downstream signal. However, the loss of power to the entry adapter prevents communication of active CATV signals by the active components. Additionally, one or more of the ports can be connected to the passive signal communication path, which lacks any active components. As such, subscriber equipment connected to these passive ports can operate in the event of power loss. For example, the passive signal communication path may be used to provide a “lifeline telephone service” that remains operative when a subscriber premises losses power.

### SUMMARY

Embodiments in accordance with the present disclosure provide a network interface device. The network interface device includes an entry port, a passive input/output port, an active input/output port, a first switching device, a second switching device, a splitter device, and an amplifier circuit. A common terminal of the first switching device connects to the entry port. A common terminal of the first switching device connects to the entry port. A common terminal of the second switching device connects to the passive input/output port. A first terminal of the splitter device connects to the entry port. A second terminal of the splitter device connects to the passive input/output port via the second switching device. A third terminal of the splitter device connects to the active input/output port via the amplifier circuit. A first terminal of the first switching device and a first terminal of the second switching device, in the event the first switching device and the second switching device are powered by the power port, provides a first bidirectional RF signal path between the entry port and the passive input/output port, and provides a bidirectional RF signal path between the entry port and the active input/output port. A second terminal of the first switching device and a second terminal of the second switching device, in the event power to the first switching device and the second switching device is interrupted, provides a second bidirectional RF signal path between the entry port and the passive input/output port.

Additionally, embodiments in accordance with the present disclosure provide a network interface device, including an active radio-frequency (RF) signal path connecting an entry port and an active port. The network interface device also includes a first passive RF signal path connecting the entry port and a passive port. The network interface device further includes a second passive RF signal path connecting the entry port and the passive port. The active RF signal path includes a first relay and a splitter/combiner device. The first passive RF signal path includes the first relay and the splitter/combiner device. The second passive RF signal path includes the first relay and a second relay. A normally-closed terminal of the first relay and a normally-closed terminal of the second relay connect such that the second passive RF signal path bypasses the splitter/combiner device.

Moreover, embodiments in accordance with the present disclosure provide network interface device including a circuit that, in a powered state, receives a downstream RF signal from a source via an entry port, provides a portion of the downstream RF signal to a first input/output port via a passive signal path, and provides a second portion of the downstream RF signal to a second input/output port via an active signal path. Additionally, in an unpowered state, the circuit receives the downstream RF signal from the source via the entry port. provides the downstream RF signal to first input/output port via a second passive signal path, and isolates the active signal path and a first passive signal path from the second passive signal path.

Other and different statements and aspects of the invention appear in the following claims. A more complete appreciation of the present invention, as well as the manner in which the present invention achieves the above and other improvements, can be obtained by reference to the following detailed description of a presently preferred embodiment taken in connection with the accompanying drawings, which are briefly summarized below, and by reference to the appended claims.

### BRIEF DESCRIPTION OF THE DRAWINGS

FIG. 1 is a functional block diagram of an exemplary network interface device in accordance with aspects of the present disclosure.

FIG. 2 is a functional block diagram of an exemplary network interface device in accordance with aspects of the present disclosure.

### DETAILED DESCRIPTION

Network interface devices in accordance with aspects of the present disclosure include a switching circuit that provides a low-loss passive signal communication path that facilitates non-interruptible communication. The switching circuit can bypass an active signal communication path in the event of a power failure or fault, while maintain bidirectional communication in the passive signal communication path. The bypassing minimizes or eliminates interference in the passive signal communication path by isolating it from noise and/or reflections generated in the active signal communication path during a power failure or fault condition.

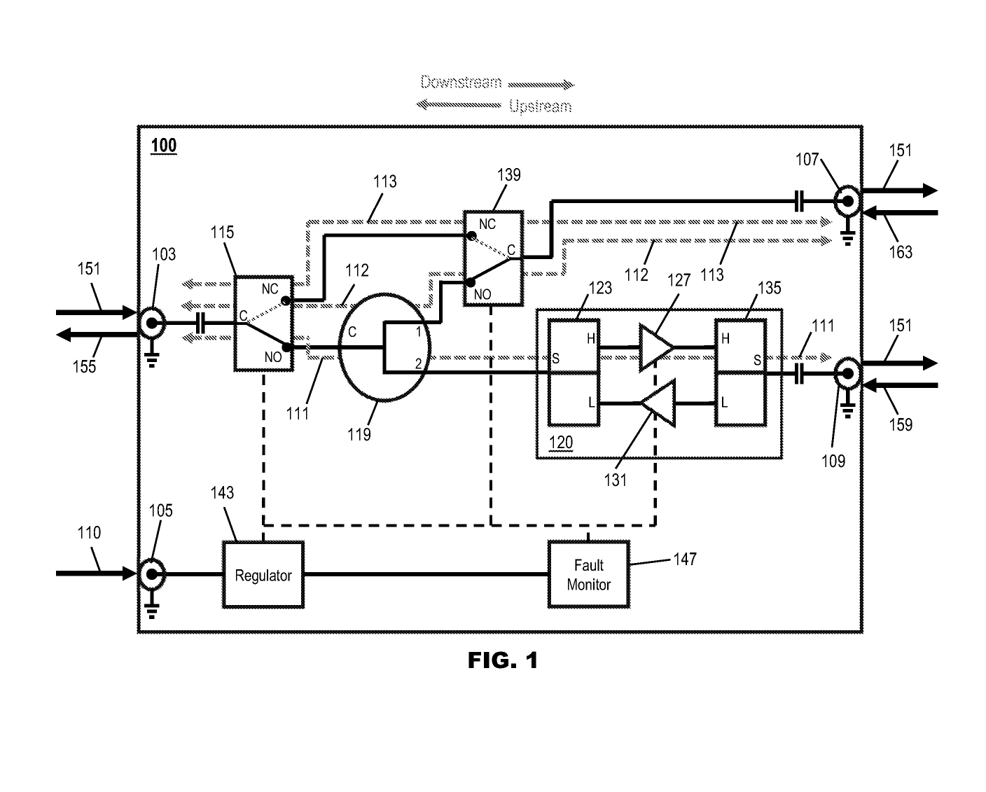

FIG. 1 is a functional block diagram of a network interface device 100 in accordance with aspects of the present disclosure. The network interface device 100 includes an entry port 103, a power input port 105, a passive port 107, and an active port 109 that make external connections for receiving radio frequency (RF) signals and power. The entry port 103 can receive downstream RF signals from a service provider, such as a CATV provider (e.g., via a drop line). The entry port 103 can also transmit upstream RF signals in the from subscriber equipment to the service provider. The power input port 105 receives power 110 from an external source for powering various devices within the network interface device 100. For example, the network interface device 100 may be powered by an AC/DC adapter that receives power from the residence (for example, 100-230 VAC, 50/60 Hz). The passive port 107 and the active port 109 communicate RF signals between the network interface device 100 to subscriber equipment. The subscriber equipment can be, for example, CATV, Internet, VoIP, and/or data communication devices installed in the residence.

In accordance with aspects of the present disclosure, the network interface device 100 includes an active signal path 111 (indicated in FIG. 1 by a dashed line) between the entry port 103 and the active port 109. Additionally, the network interface device 100 includes a first passive signal path 112 (indicated in FIG. 1 by another dashed line) between the entry port 103 and the passive port 107. Further, the network interface device 100 includes a second passive signal path 113 (indicated in FIG. 1 by yet another dashed line) between the entry port 103 and the passive port 107. The active signal communication path 111 includes a switching device 115, a splitter 119, and an amplifier circuit 120, which communicatively link bidirectional RF signals between the entry port 103 and the active port 109. In embodiments, the amplifier circuit 120 can include a first diplexer 123, a downstream amplifier 127, upstream amplifier 131, and a second diplexer 135. The first passive signal path 112 includes the first switching device 115, the splitter/combiner 119, and a second switching device 139, which transmit bidirectional RF signals between the entry port 103 and the passive port 107. The second passive signal communication path 113 includes the first switching device 115 and a second switching device 139, but may omit the splitter/combiner 119. The second passive signal path 113 may transmit bidirectional RF signals between the entry port 103 and the passive port 107.

The switching devices 115 and 139 provide a switching circuit that can bypass the splitter/combiner 119. For example, in the event of a power loss or fault, the switching devices 115 and 139 provide bidirectional communication between the entry port 103 and the passive port 107 via the second passive signal path 113, while isolating the second passive signal path 113 from interference (e.g., noise and/or reflections) generated by the active signal communication path 111 when active devices (e.g., amplifiers 127 and 131) are unpowered.

In implementations, the switches 115 and 139 can be relays that bypass the splitter combiner in the event they are unpowered (e.g., power loss from power source, regulator 143 or fault detection by fault monitor 147). For example, the switching devices 115 and 139 can have a common terminal (C), a normally-closed (NC) terminal and a normally-open (NO) terminal, wherein the common terminal (C) is conductively connected to the normally-closed terminal (NC) when the switching devices 115 and 139 are not powered. On the other hand, the common terminal (C) is conductively connected to the normally-open (NO) terminal when the switching devices 115 and 139 are powered. When energized with an operating voltage provided from the power input port 105 via, e.g., a regulator 143 and/or fault monitor 147, the switching devices 115 and 139 are placed in a first state in which the common terminal (C) connects to the normally-open terminal (NO). And, when switching device 115 is not energized, the common terminal (C) connects to the normally-closed terminal (NC). Thus, the common terminal (C) of each of switching devices 115 and 139 connects to the normally-closed terminals (NC) if the network interface device 100 loses power. In some embodiments, the switching devices 115 and 139 are mechanical relays. In other embodiments, the switching devices 115 and 139 are solid state relays. While switching devices 115 and 139 in the example above and illustrated in FIG. 1 are described as single-pole, dual-throw (SPDT) non-latching relays, it is understood that other types of switching devices can be used (e.g., dual-pole, dual-throw non-latching relays).

The splitter/combiner 119 is a passive device that divides a signal received at a common terminal (C) into a number of signals. In implementations the splitter/combiner is a 1-to-N splitter combiner, wherein in N is a positive integer value. For example, the splitter combiner 119 can be a 1-to-2 (i.e., one-in, two out) splitter/combiner, that splits the downstream RF signal 151 into two signals, which are respectively output at a first terminal (1) and second terminal (2). In the reverse direction, the splitter/combiner 119 can combine upstream RF signals 159 and 163 received at the first terminal (1) and second terminal (2) into a combined RF signal 155, which is output at the common terminal (C).

The diplexers 123 and 135 can be passive devices that separate signals received at a common terminal (S) into a high frequency band and a low frequency band. The high frequency band signals is output from the high terminal (H) and the low frequency band signals are output from the low terminal (L). In the reverse direction, the diplexers 123 and 135 multiplex signals received at the high terminal (H) and the low terminal (L) into a single signal, which is output from the common terminal (C). In some embodiments, the diplexers 123 and 135 filter RF signals such that frequencies greater than about 45-50 MHz (e.g., a CATV downstream frequency band) are passed from the common terminal (C) to the high terminal (H), and vice versa. Additionally, in the reverse direction, the diplexers 123 and 135 filter RF signals such that frequencies lower than about 45-50 MHz (e.g., a CATV upstream signal) are passed through from the common terminal (C) to the low terminal (L), and vice versa.

During normal operation, the network interface device 100 (and the various powered or active components contained therein) is powered via power 110 received via the power input port 105. Accordingly, as discussed in greater detail below, the switching devices 115 and 139 communicate the downstream RF signal 151 to the active signal path 111 and the first passive signal path 112 via the splitter/combiner 119. On the other hand, the switching devices 115 and 139 communicate the downstream RF signal 151 solely to the second passive signal path 113 without passing through the splitter/combiner 119 in the event the network interface device is operated without the power 110 and/or a fault monitor 147 interrupts the power 110. In other words, when the network interface device 100 is operated without the power 110 provided to regulator 143, and/or when the power 110 is interrupted by a fault monitor 147, the switching devices 115 and 139 bypass the splitter/combiner 119. The fault monitor 147 can interrupt power after detecting, for example, a voltage loss, a voltage surge, a high current, and/or a low current condition in the power 110. By doing so, the passive input/output port 107 can receive the entire, undivided downstream RF signal 151. Additionally, as the switching devices 115 and 139 divert the downstream RF signal 151, the active signal path 111 may not be terminated. Thus, the network interface device 100 can avoid loss of signal power to a terminator, since such a terminator for the active signal path 111 may be omitted. Additionally, the network interface device 100 can avoid noise from reflections that might otherwise occur if a portion of the downstream signal path 111 was terminated.

For example, in accordance with aspects of the present disclosure, the first switching device 115 receives the downstream RF signal 151 as an input from the entry port 103 via its common terminal (C). When the first switching device 115 is powered, the common terminal (C) connects to the normally-open terminal (NO) (as indicated by the solid line between C and NO). Accordingly, the downstream RF signal 151 is communicated to the normally-open terminal (NO), which is output to the common terminal (C) of the splitter/combiner 119. As is described above, the splitter/combiner 119 splits the downstream RF signal 151 into two portions that are respectively output from the common terminal (C) and the second terminal (2) of the splitter/combiner 119. In embodiments, the splitter/combiner 119 splits the downstream RF signal 151 into two substantially equal portions. However, it is understood that the splitter/combiner 119 could be configured to split the downstream RF signal 151 into non-equal portions. For example, as the portion of the downstream RF signal 151 provided to the third terminal is fed to the active signal path 111 for amplification by amplifier 127, the splitter/combiner 119 can be configured to provide a majority (e.g., >50%) of the downstream RF signal 157 to the second terminal, which feeds the first passive signal path 112.

In accordance with aspects of the present disclosure, the first terminal (1) of the splitter/combiner 119 provides a first portion of the downstream RF signal 151 as an input to the normally-open terminal (NO) of the second switching device 139. During normal operations in which the network interface device 100 is powered, such the first terminal (1) of the second switching device 139 is conductively connected to the common terminal (C) (as indicated by the solid line between NO and C). Accordingly, the first portion of the downstream RF signal 151 is output to the passive port 107 via the first passive signal path 112 during normal operations. The passive port 107 may be connected to passive subscriber equipment, such as a VOIP telephone.

Additionally, as described above, the second terminal (2) of the splitter/combiner 119 provides a second portion of the downstream RF signal 151 as an input to the active port 109 via the amplifier circuit 120. In embodiments, splitter/combiner 119 outputs the downstream RF signal 151 to the common terminal (S) of the first diplexer 123, which then outputs the signal from its high terminal (H) to an input of the downstream amplifier 127. The downstream amplifier 127 amplifies (e.g., buffers) the downstream RF signal 151 and outputs it to high terminal (H) of the second diplexer 135. The second diplexer 135 then outputs the signal from the common terminal (S) to the active input/output port 109. The active input/output port 109 can be connected to subscriber equipment, such as a set top box, a television, or a computer modem.

Now referring to the downstream signal flow through the network interface device 100 when power is lost or interrupted, the first switching device 115 receives the downstream RF signal 151 as described previously. However, as this relay is not powered, the common terminal (C) of the first switching device 115 is conductively connected to the normally-closed terminal (NC) (as indicated by the dashed line between C and NC). Accordingly, the first switching device 115 bypasses the splitter/combiner 119 and provides the entire downstream RF signal 151 as an input to the normally-closed terminal (NC) of the second switching device 139. And, as the second switching device 139 is also not powered, the normally-closed terminal (NC) of the second switching device 139 is conductively connected to the common terminal (C), as indicated by the dashed line between NO and C). The common terminal (C) of the second switching device 139 outputs to the passive port 107, such that the entire downstream RF signal 151 is provided to the passive port 107.

Now referring to the upstream (i.e., reverse) signal flow through the active signal communication path 111, an upstream RF signal 159 received by the network interface device 100 from subscriber equipment in communication with the active input/output port 109 is provided as an input to the common terminal (S) of the second diplexer 135. As detailed above, the second diplexer 135 separates the active upstream RF signal 159 from any high-frequency signal, such as the downstream RF signal 151. In embodiments, the active upstream RF signal 159 output from the low frequency terminal (L) by the diplexer 135 can be amplified and/or conditioned by the upstream amplifier 131. The active upstream RF signal 159 is passed to the first diplexer 123. The upstream active RF signal 159 can then be provided as an input to the second terminal (2) of the splitter/combiner 119. In the upstream direction, the splitter/combiner 119 combines the upstream RF signal 159 with a passive upstream RF signal 163 received by the common terminal (C) of the splitter/combiner 119. The combined upstream RF signal 155 is provided by the common terminal (C) of the splitter/combiner 119 as an input to the normally-open terminal (NO) of the first switching device 115. In turn, during powered operation of the network interface device 100, the normally-open terminal (NO) of the first switching device 115 provides the upstream RF signal 155 to the common terminal (C). The common terminal (C) then outputs upstream RF signal 155 to the entry port 103, which can output such signal to the service infrastructure.

Now referring to the upstream signal flow through the first passive signal path 112, the passive upstream RF signal 163 received by the network interface device 100 from subscriber equipment in communication with the passive input/output port 107 is provided as an input to the common terminal (C) of the second switching device 139. Because the relay is powered during normal operations of the network interface device 100, the common terminal (C) is connected to the normally-open terminal (NO) of the second switching device 139. The normally-open terminal (NO) provides the passive upstream RF signal 163 to the first terminal (1) of the splitter/combiner 119, which combines it with the active upstream RF signal 153 and outputs the combined signal to the entry port 103, as described above.

Now referring to the upstream signal flow through the second passive signal path 113, the passive upstream RF signal 163 received by the network interface device 100 from subscriber equipment in communication with the passive input/output port 109 is provided as an input to the common terminal (C) of the second switching device 139, as described above. In the situations the network interface device 100 is not powered or is interrupted (e.g., by fault monitor 147), the common terminal (C) of the second switching device 139 is connected to the normally-closed terminal (NC) (as indicated by the dashed line between C and NC). The normally-closed terminal (NC) provides the passive upstream RF signal 163 as an input to the normally-closed terminal (NC) of the first switching device 115. And, as the network interface device 100 is not powered, the normally-closed terminal (NC) provides the passive upstream RF signal 163 to the common terminal (C) of the first switching device 115 (as indicated by the dashed line connecting NC and C). By doing so, the passive upstream RF signal 163 bypasses the splitter/combiner 119. Because this signal is not split by the splitter/combiner 119, the entire passive upstream RF signal 163 is provided to the entry port 103. Accordingly, the second passive signal path 113 can communicate signals between a CATV network connected to the entry port 103, and a VOIP device in a subscriber premises connected to the downstream passive input/output port 107 when the network interface device 100 is not powered. Thus, the second passive signal path 113 permits communication of at least one or more services, such as emergency 911 telephone service.

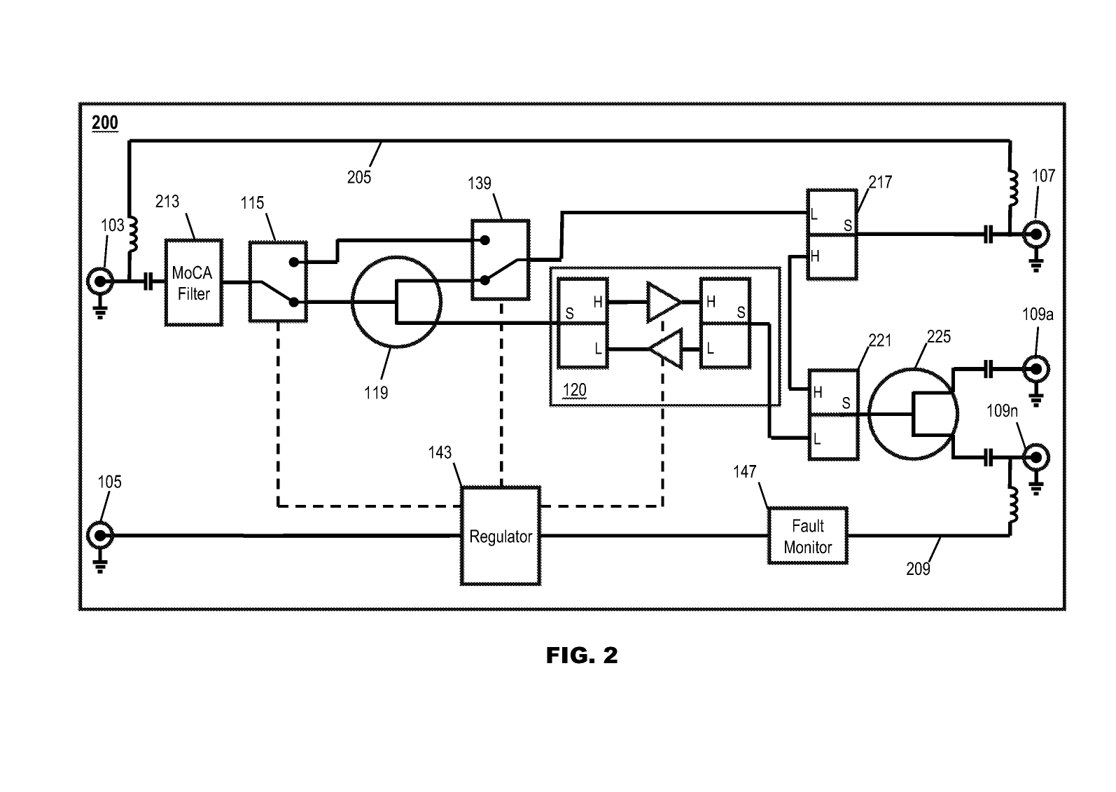

FIG. 2 is a functional block diagram of a network interface device 200 in accordance with aspects of the present disclosure. Network interface device 200 includes an entry port 103, a power input port 105, a passive port 107, an active ports 109a. . . 109n, a first switching device 115, a splitter/combiner 119, a first diplexer 123, downstream amplifier 127, upstream amplifier 131, and second diplexer 135, which are the same or similar to those previously described herein. Additionally, embodiments of the network interface device 200 include a power passing connection 205, remote power connection 209, a Multimedia over Coax Alliance (MoCA) point of entry filter 213, a third diplexer 217, a fourth diplexer 221, and a n-way splitter 225. Further, some embodiments of the network interface device 200 include a Multimedia over Coax Alliance (MoCA) point of entry filter 213, The power passing connection 205 allows inline power that may be provided by an input signal to be transmitted between ports 103 and 107. Similarly, remote power connection 209 may provide power from the regulator 143 and/or fault monitor 147 to the active port 109n.

The MoCA filter 213 prevents the potential leakage of subscriber information including in MoCA signals transmitted among MoCA-enabled subscriber equipment. For example, the MoCA filter 213 can filter frequencies above about 1125 MHz that may otherwise leak out the entry port 103.

The diplexers 217 and 221 can be the same or similar to those previously described herein. In embodiments, the diplexers 217 and 221 can be configured to separate high-frequency MoCA signals received via ports 107 and ports 109a. . . 109n, and pass the between such ports. Accordingly, a MoCA-enabled equipment connected to passive port 107 can communicate with MoCA enabled devices connected to active ports 109a. . . 109n. Additionally, the diplexers 217 and 221 separate low-frequency (CATV) upstream RF signals and pass them to the entry port 103 in a similar manner to that previously describe herein. The Low pass section of diplexers 217 and 221 also function to prevent the potential leakage of subscriber information including in MoCA signals transmitted among MoCA-enabled subscriber equipment. For example, the MoCA filter 213 can filter frequencies above about 1125 MHz that may otherwise leak out the entry port 103

The n-way splitter 225 (e.g. power divider) divides downstream signal, where it is distributed to any of ports 109a. . . 109n. In the upstream direction, through the active communication path devices in communication with ports 109a. . . 109n can be passed to fourth diplexer 221, which combines them into a composite upstream RF signal. Accordingly, the network interface device 200 can communicate with a number (N) of subscriber equipment devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What we claim is:

1. A network interface device, comprising:
an entry port;
a power port;
a passive input/output port;
an active input/output port;
a first switching device;
a second switching device;
a splitter device; and
an amplifier circuit;
wherein:
a common terminal of the first switching device connects to the entry port;
a common terminal of the second switching device connects to the passive input/output port;
a first terminal of the splitter device connects to the entry port;
a second terminal of the splitter device connects to the passive input/output port via the second switching device;
a third terminal of the splitter device connects to the active input/output port via the amplifier circuit;
a first terminal of the first switching device and a first terminal of the second switching device are configured to, in the event the first switching device and the second switching device are powered by the power port:
provide a first bidirectional RF signal path between the entry port and the passive input/output port, and
provide a bidirectional RF signal path between the entry port and the active input/output port; and
a second terminal of the first switching device and a second terminal of the second switching device are configured to, in the event power to the first switching device and the second switching device is interrupted, provide a second bidirectional RF signal path between the entry port and the passive input/output port.

2. The network interface device of claim 1, wherein the first switching device and the second switching device are non-latching relays.

3. The network interface device of claim 1, wherein the amplifier circuit comprises:
a first diplexer;
a second diplexer; and
a downstream amplifier configured to amplify a downstream RF signal.

4. The network interface device of claim 3, wherein the amplifier circuit further comprises an upstream amplifier configured to amplify an upstream RF signal.

5. The network device of claim 1, wherein the first switching device, the splitter device, and the amplifier circuit at least partially define the bidirectional RF signal path between the entry port and the active input/output port.

6. The network interface device of claim 1, wherein the first switching device, the splitter device, and the second switching device at least partially define the first bidirectional RF signal path between the entry port and the passive input/output port.

7. The network interface device of claim 6, wherein the first bidirectional RF signal path between the entry port and the passive input/output port lacks any active devices.

8. The network interface device of claim 1, wherein the first switching device and the splitter device at least partially define the second bidirectional RF signal path between the entry port and the passive input/output port.

9. The network interface device of claim 8, wherein the second bidirectional RF signal path between the entry port and the passive input/output port bypasses the splitter device and the amplifier circuit.

10. The network interface device of claim 8, wherein the second bidirectional RF signal path between the entry port and the passive input/output port lacks any active devices.

11. A network interface device, comprising:
an active radio-frequency (RF) signal path connecting an entry port and an active port;
a first passive RF signal path connecting the entry port and a passive port;
a second passive RF signal path connecting the entry port and the passive port;
wherein:
the active RF signal path includes a first switching device and a splitter/combiner device;
the first passive RF signal path includes the first switching device and the splitter/combiner device; and
the second passive RF signal path includes the first switching device and a second switching device;
wherein the first switching device and the second switching device are configured to bypass the splitter/combiner device.

12. The network interface device of claim 11, wherein the first passive RF signal path and the second passive RF signal path include only non-active devices.

13. The network interface device of claim 11, wherein a first terminal of the splitter/combiner device is configured to receive a downstream RF signal.

14. The network interface device of claim 13, wherein a second terminal of the splitter/combiner is configured to output a first portion of the downstream RF signal to the second relay.

15. The network interface device of claim 14, wherein a third terminal of the splitter/combiner device is configured to output a second portion of the downstream RF signal to an amplifier circuit.

16. The network interface device of claim 11, wherein a common terminal of the first relay is configured to receive a downstream RF signal as an input.

17. The network interface device of claim 16, wherein a normally-open terminal of the first relay is configured to provide the downstream RF signal to a common terminal of the splitter/combiner device.

18. The network interface device of claim 16, wherein a normally-closed terminal of the first relay is configured to provide the downstream RF signal to a normally-closed terminal of the second relay.

19. The network interface device of claim 16, wherein a common terminal of the second relay is configured to output the downstream RF signal to the passive port.

20. A network interface device comprising a circuit, wherein:
in a powered state, the circuit is configured to:
receive a downstream radio-frequency (RF) signal from a source via an entry port;
provide a first portion of the downstream RF signal to first input/output port via a first passive signal path; and
provide a second portion of the downstream RF signal to a second input/output port via an active signal path; and
in an unpowered state, the circuit is configured to:
receive the downstream RF signal from the source via the entry port;
provide the downstream RF signal to first input/output port via a second passive signal path; and
isolate the active signal path and a first passive signal path from the second passive signal path.
